(19) United States
(12) Patent Application Publication
(10) Pub. No.: US 2010/0113627 A1
(43) Pub. Date: May 6, 2010

(54) WATER-BASED COATING-TYPE DAMPING MATERIAL

(76) Inventors: Shota MATSUMOTO, Toyota-shi (JP); Haruhisa Suzuki, Toyota-shi (JP); Junichi Kawai, Aichi-gun (JP); Masaki Kawai, Okazaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/611,174

(22) Filed: Nov. 3, 2009

(30) Foreign Application Priority Data
Nov. 5, 2008 (JP) 2008-284456

(51) Int. Cl. C08J 9/16

(52) U.S. Cl. 521/59

(57) ABSTRACT

This invention provides a water-based coating-type damping material whereby detachment or deformation of a sealer can be prevented and anti-blister performance can be improved.

Such water-based coating-type damping material comprises at least an aqueous resin emulsion, an inorganic filler, a water retention agent that retains the moisture of the resin emulsion, and microballoon particles comprising balloons encapsulating an expansion agent that is evaporated by heating so as to expand, the microballoon particles starting to expand in the presence of the expansion agent under heating temperature conditions of the water boiling point or lower.

### BACKGROUND OF THE INVENTION

1. Field of the Invention

The present invention relates to a water-based coating-type damping material containing a resin emulsion and an inorganic filler. In particular, the present invention relates to a water-based coating-type damping material preferably used for vehicle floors and the like.

2. Background Art

Hitherto, in order to prevent vibration, sheet-type damping materials mainly consisting of asphalt have been applied to vehicle floors and the like. However, in order to apply such a sheet-type damping material, an operator must cut the damping material to conform with the shape of the relevant portion and apply the material to the portion. This has been an obstacle in automation, resulting in failure to reduce the time required for operation.

In view of the above circumstances, damping compositions (water-based coating-type damping materials) used for automated coating by a robot have been developed. For instance, an example of a water-based coating-type damping material that has been suggested is a water-based coating-type damping material containing a resin emulsion, an inorganic filler, and a heat-expandable organic hollow material (see JP Patent Publication (Kokai) No. 7-145331 A (1995), etc.).

Such water-based coating-type damping material allows automation using a coating robot and reduction of the time required for operation. In addition, since it is a water-based coating agent, no odor is generated when it is used, unlike the cases of conventional sheet-type damping materials that cause generation of an asphalt-like odor or an organic solvent-like odor derived from an organic solvent-based coating agent.

Further, the use of a heat-expandable organic hollow material allows a water-based coating agent to be obtained that is capable of achieving a significantly higher limit film thickness than conventional water-based resin coating agents, such that no small holes/cracks are formed thereon. In addition, the desired film thickness can be achieved by single coating and therefore such water-based coating agent has damping performance comparable to conventional sheet-type damping materials.

### SUMMARY OF THE INVENTION

When the water-based coating-type damping material of JP Patent Publication (Kokai) No. 7-145331 A (1995) is used, detachment or deformation of a sealer can be observed in some cases if a sealer and the water-based coating-type damping material are applied in layers to the surface of a steel plate and the plate is allowed to stand for several hours.

As shown in FIG. 3(a), when a coat 95 of a water-based coating-type damping material and a sealer 92 are applied in layers to a coating steel plate 91 and the plate has been allowed to stand for several hours, skinning of the surface 95a of the coat 95 is caused due to dryness, resulting in insufficient release of water contained the coat 95 (water-based coating-type damping material). The sealer 92 is a sealing composition intended to prevent water or dust infiltration through joints and seams on the steel plate and rust formation.

Accordingly, as shown in FIG. 3(b), if baking is carried out when there is insufficient release of water, water vapor remains in gaps between a damping material 95 (coat) and a sealer 92 when the moisture in the coat 95 is evaporated. Gelling of the sealer 92 takes place before gelling of the coat 95 (water-based coating-type damping material). Therefore, detachment or deformation of the sealer 92 is caused by water vapor when the water vapor pressure increases before allowing secure adhesion.

In view of the above, it would be possible, for instance, to prevent skinning on the coat surface by adding a water retention agent to a water-based coating-type damping material. However, when the content of a water retention agent is large, formation of blisters upon electrodeposition might be caused by baking. Such phenomenon of formation of blisters upon electrodeposition is described below. When a coating-type damping material is applied to the coat of an electrodeposition coating agent used for vehicle body panels and the like, followed by baking, a water retention agent causes swelling and softening of the electrodeposited coat. Then, warm water used for immersion permeates the softened electrodeposited coat and infiltrates the interface between the electrodeposited coat and the steel plate, resulting in formation of small blisters (swelling portions) on the electrodeposited coat.

The present invention has been made in view of the above problems. It is an object of the present invention to provide a water-based coating-type damping material whereby detachment or deformation of a sealer can be prevented and anti-blister performance can be improved.

In order to achieve the above object, the water-based coating-type damping material of the present invention is a water-based coating-type damping material comprising at least an aqueous resin emulsion, an inorganic filler, a water retention agent that retains the moisture of the resin emulsion, and microballoon particles comprising balloons encapsulating an expansion agent that is evaporated by heating so as to expand. Such microballoon particles start to expand in the presence of the expansion agent under heating temperature conditions of the water boiling point or lower.

According to the present invention, a water-based coating-type damping material used for coating is heated such that an expansion agent encapsulated in each microballoon particle is evaporated, resulting in internal pressurization in each balloon. As a result, the microballoon particles expand such that the uncured semi-solid water-based coating-type damping material is enlarged, resulting in formation of cracks in the damping material and leading to foam formation.

In particular, microballoon particles in the water-based coating-type damping material (damping material) of the present invention start to expand at a heating temperature at the water boiling point or lower. Therefore, micropores are formed inside or on the surface of the damping material before water vapor contained in the damping material (such water vapor being generated during baking curing) affects (attacks) a sealer. Accordingly, moisture is rapidly released from the damping material without being rapidly boiled inside thereof such that deformation and detachment of the sealer can be prevented.

Further, as a result of such improvement of water release properties of the damping material, blisters are unlikely to be formed. Therefore, the amount of water retention agent can be increased. As a result, dryness of the surface of a water-based coating-type damping material is alleviated after coating, resulting in prevention of skinning of the surface and swelling upon heating.

Preferably, the content of the water retention agent in the water-based coating-type damping material of the present invention is 1.5% to 3.0% by mass. According to the present invention, when the content of the water retention agent falls within the above range, deformation of a sealer and formation of blisters upon electrodeposition can be prevented.

When the content of the water retention agent is less than 1.5% by mass, skinning tends to be observed on the surface of a coat, resulting in insufficient water release. In addition, upon baking, when moisture in the damping material is evaporated, water vapor tends to remain in gaps between the damping material and the sealer, facilitating detachment or deformation of the sealer. Further, when the content of the water retention agent exceeds 3.0% by mass, the moisture content in the water retention agent is large, and therefore formation of blisters upon electrodeposition is likely to be caused.

In the case of the water-based coating-type damping material of the present invention, the temperature at which the microballoon particles start to expand is preferably 80° C. or higher. According to the present invention, when microballoon particles expand at 80° C. or higher, it is possible to allow such microballoon particles to expand in a preferable manner upon baking after coating. Specifically, when microballoon particles expand at less than 80° C., they might expand before the water-based coating-type damping material is used for coating, resulting in cost increase for the storage of a water-based coating-type damping material before it has been used for coating.

Preferably, in the case of the water-based coating-type damping material of the present invention, the microballoon particles encapsulate the expansion agent in an amount that allows the microballoon particles to expand in a volume at least 8 times as great as the initial volume via heating. According to the present invention, water release properties of the water-based coating-type damping material upon baking can be further improved by allowing the microballoon particles to expand in a volume at least 8 times as great as the non-expanded volume upon baking (heating at the water boiling point or higher).

More preferably, in the case of the water-based coating-type damping material of the present invention, the expansion agent is hydrocarbon and the water retention agent is propylene glycol. According to the present invention, a water-based coating-type damping material having the above functions can be obtained at a low cost with the use of the above materials.

### EFFECTS OF THE INVENTION

According to the present invention, detachment or deformation of a sealer can be prevented and anti-blister performance can be improved.

### BRIEF DESCRIPTION OF THE DRAWINGS

FIG. 1 is an explanatory view of a microballoon particle contained in a water-based coating-type damping material used in embodiments of the present invention.

Each of FIGS. 2(a) and 2(b) shows an explanatory view of the state of a coat obtained after coating with a water-based coating-type damping material used in embodiments of the present invention. FIG. 2(a) is an explanatory view of the state of the coat immediately after coating with the damping material. FIG. 2(b) is an explanatory view of the state of the damping material upon baking of the coat.

Each of FIGS. 3(a) and 3(b) shows an explanatory view of the state of a coat obtained after coating with a conventional water-based coating-type damping material. FIG. 3(a) is an explanatory view of the state of the coat immediately after coating with the damping material. FIG. 3(b) is an explanatory view of the state of the damping material upon baking of the coat.

### EXPLANATION OF REFERENCE NUMERALS

10A: non-expanded microballoon particle; 10B: expanded microballoon particle; 11: balloon; 12: expansion agent; 21: steel plate; 22: sealer; 25: coat; and 25a: coat surface

### DESCRIPTION OF THE PREFERRED EMBODIMENTS

First, a method for producing a water-based coating-type damping material used in embodiments of the present invention is described below. First, a liquid resin emulsion is introduced into a cup or beaker. An additive is added thereto and an inorganic filler is mixed therewith, followed by mixing until a homogenous mixture can be obtained. Further, a water retention agent and microballoon particles are added thereto, followed by mixing until a homogenous mixture can be obtained. Thereafter, the mixture is transferred to a container for defoaming and the container is placed in a defoaming apparatus. Defoaming is carried out via agitation during suction using a vacuum pump. Production of a water-based coating-type damping material is completed after the above steps.

In the embodiments of the present invention, an acryl emulsion is used as a resin emulsion. Calcium carbonate and mica are used as inorganic fillers. In addition, propylene glycol is used as a water retention agent and microballoon particles are added as foaming agents to a damping material. Further, it is also possible to add other known additives (an antifoaming agent, a dispersant, a thickener, and a fluidity-decreasing agent). For the purpose of coating, material properties such as viscosity can be adjusted.

In the embodiments of the present invention, an example of an aqueous resin emulsion is an aqueous emulsion comprising an acryl resin. In addition to such example, a styrene-butadiene copolymer emulsion, an acryl emulsion, an acryl-styrene emulsion, a styrene-butadiene-latex (SBR) emulsion, a vinyl acetate emulsion, an ethylene-vinyl acetate emulsion, an ethylene-acryl emulsion, an epoxy resin emulsion, an urethane resin emulsion, a phenol resin emulsion, a polyester resin emulsion, or an acrylonitrile-butadiene-latex (NBR) emulsion may be used. A resin contained in such a resin emulsion is not particularly limited as long as it has molecular properties that allow conversion of vibration energy at around the glass transition temperature into heat energy, thereby exhibiting damping performance.

In the embodiments of the present invention, examples of inorganic fillers are calcium carbonate and mica. However, in addition to such examples, talc, diatomaceous earth, barium sulfate, zeolite, magnesium carbonate, graphite, calcium silicate, clay, glass flakes, vermiculite, kaolinite, wollastonite, and the like can be used.

In particular, calcium carbonate, barium sulfide, talc, and the like can function as filling fillers. Mica, wollastonite, and the like can function as damping fillers. Such a damping filler is mixed well with a resin contained in a resin emulsion upon baking such that damping performance can be further improved.

In view of general versatility, propylene glycol is described herein as an example of a water retention agent in the embodiments of the present invention. However, in addition to the above, a water retention agent can be selected from the group consisting of glycols such as ethylene glycol and diethylene glycol; glycerols such as glycerine; polyols such as polyethylene glycol and polyglycerine; and derivatives and mixtures thereof. However, a water retention agent is not limited to such examples as long as it can retain moisture contained in a resin emulsion such that drying of the surface of a water-based coating-type damping material can be prevented after coating.

In addition, as a result of experiments conducted by the inventors described below, it has been found that the content of a water retention agent in a water-based coating-type damping material is preferably 1.5% to 3.0% by mass. When the content of a water retention agent in a water-based coating-type damping material falls within the above range, deformation of a sealer and formation of blisters upon electrodeposition can be prevented. Specifically, when the content of a water retention agent is less than 1.5% by mass, a sealer covered with a damping material might be deformed upon baking. Further, detachment of a sealer in the interface between the sealer and an electrodeposited coat might be caused. In addition, when the content of a water retention agent is more than 3.0% by mass, formation of blisters upon electrodeposition might be caused.

Microballoon particles are balloon particles each having an outer shell composed of an expandable/contractable polymer compound and encapsulating a liquid hydrocarbon expansion agent, which start to expand under heating temperature conditions of the water boiling point or lower. Herein, the water boiling point is the boiling point of moisture contained in a water-based coating-type damping material. In general, the water boiling point under a pressure environment of 1 atmospheric pressure is 100° C. For instance, under a general pressure environment at 1 atmospheric pressure, a microballoon particle 10A is allowed to expand at 100° C. or lower. In view of the object of the present invention, it is important for a microballoon particle 10A to be allowed to expand before boiling of water (moisture in a resin emulsion) contained in a water-based coating-type damping material upon baking following coating. Therefore, it is preferable to determine the temperature for the initiation of expansion of a microballoon particle 10A based on the water boiling point that would vary depending on conditions of the pressure environment upon baking.

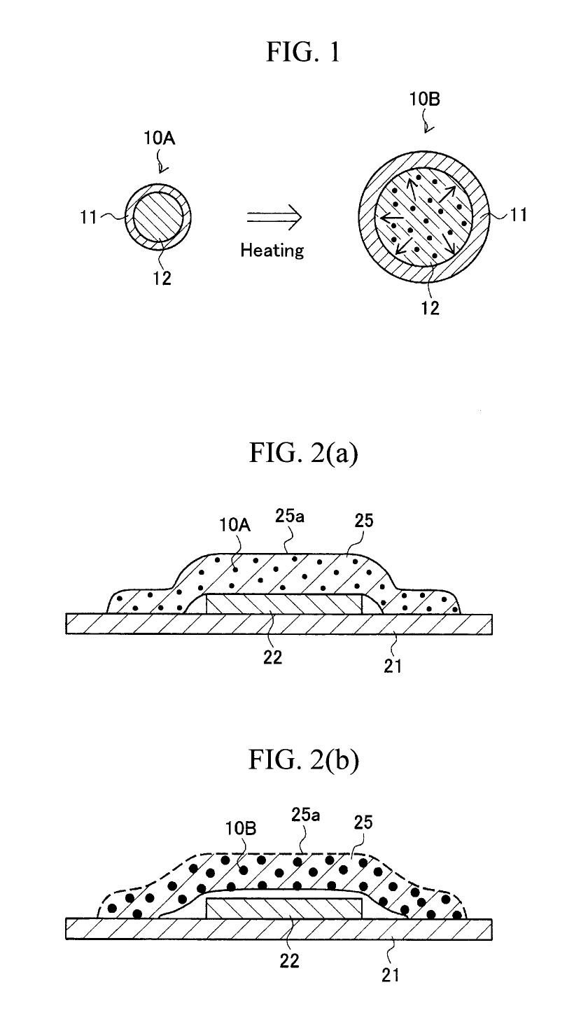

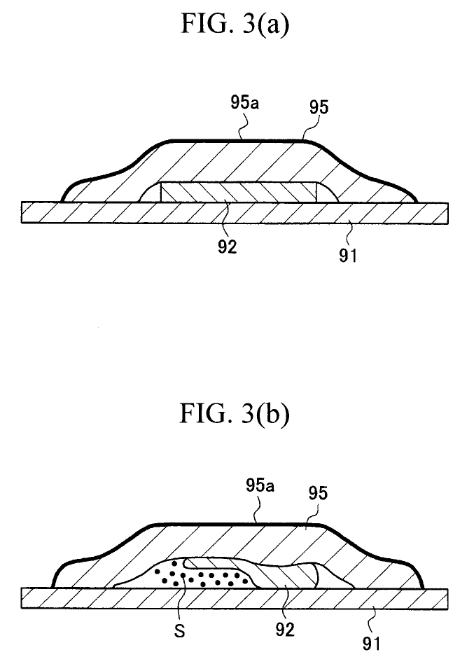

Specifically, as shown in FIG. 1, a microballoon particle 10A has a balloon 11 serving as an outer shell of a polymer resin compound and an expansion agent 12 encapsulated in the balloon. The particle size of a microballoon particle 10A is 10 to 20 μm. As described above, a microballoon particle 10A is a microsphere, and therefore micropores are formed in a damping material upon heating expansion.

A balloon 11 comprises a resin. Examples of such a resin include polyvinylidene chloride, polyacrylnitrile, polystyrene, polyethylene, polymethyl methacrylate, polyamide, polyester, polyurethane, and copolymers thereof. Of these, a resin having a glass transition temperature in a temperature range including the water boiling point or lower is preferable.

An expansion agent 12 is an agent that can be evaporated and gasified so as to expand at a heating temperature at at least the water boiling point or lower. For instance, it is preferable to use a liquid expansion agent comprising a low-boiling-point hydrocarbon such as butane or isobutane, which has a carbon number of 4 to 6. Such preferable hydrocarbon expansion agent 12 has a lower specific gravity than other expansion agents. As shown in FIG. 1, it is evaporated (gasified) when heated at at least 80° C. or higher, resulting in internal pressurization in a balloon 11. In such case, a microballoon particle 10A expands so as to be in the state of a microballoon particle 10B with a higher volume expansion rate.

Further, the volume expansion rate of a microballoon particle 10A can be determined based on type of a resin that constitutes a balloon 11 and the content of the hydrocarbon expansion agent 12 to be encapsulated. Preferably, a microballoon particle 10A starts to expand at 80° C. or higher. In addition, according to the experiments conducted by the present inventors described below, it is further preferable for a microballoon particle 10A to encapsulate an expansion agent. Thus, when a microballoon particle 10A at room temperature (in its unexpanded state) is heated at an expansion initiation temperature of 80° C., it expands so as to be in the state of a microballoon particle 10B, with a volume 8 times as great as the initial volume at a heating temperature of 120° C.

Such microballoon particle 10A can be used for inks for three-dimensional printing. Examples thereof include: Matsumoto Microsphere-F-30, -F-30VS, -F-46, -F-50, -F-55, -F-77, -F-80, and -F-100 series (Matsumoto Yushi-Seiyaku Co., Ltd.); unexpanded EXPANCEL microsphere-051, -053, -092, -009-80, -551, and -461 series (Japan Fillite Co., Ltd.); and CELLPOWDER series and EMARCEL BA (EIWA CHEMICAL IND. CO., LTD.).

The above water-based coating-type damping material is used in the following manner. First, as shown in FIG. 2(a), a sealer 22 is provided to a coating steel plate 21. The sealer 22 is a sealing composition used for avoiding water or dust infiltration through joints or seams on a steel plate and rust formation. Next, with the use of a spray gun for spray coating or an airless coating method, a water-based coating-type damping material containing microballoon particles 10A is applied in layers via coating over the surface of the coating steel plate to which the sealer 22 has been provided, such that a coat 25 comprising the water-based coating-type damping material is formed.

Subsequently, the coat 25 is subjected to baking and curing, generally at a temperature of 70° C. to 200° C. for 5 to 30 minutes. In this case, drying of the surface 25a of the coat 25 can be prevented with the use of a water retention agent. As a result, skinning of the surface 25a can be prevented after coating. In addition, as shown in FIG. 2(b), microballoon particles 10A contained in the water-based coating-type damping material 24 expand such that the uncured semi-solid water-based coating-type damping material is enlarged, resulting in formation of cracks in the damping material.

Accordingly, moisture contained in the coat 25 is quickly released therefrom and thus swelling of the coat caused by rapid boiling of moisture can be prevented. In particular, microballoon particles start to expand under heating temperature conditions at the water boiling point or lower (e.g., 80° C.). Therefore, micropores are formed on the surface 25a of the coat before water vapor contained in the coat 25 affects (attacks) a sealer 22 such that deformation and detachment of the sealer 22 can be prevented.

In addition, as a result of expansion of microballoon particles 10A, water release properties can be improved. Therefore, the amount of the water retention agent can be increased. As a result of such increase in the amount of the water retention agent, dryness of the surface of the coat 25 is alleviated, resulting in prevention of skinning of the surface 25a and swelling upon heating. Further, cracks are unlikely to be formed in the wet coat in a state of standing still before heating. Accordingly, dry dust is unlikely to adhere to the tip portion of a nozzle during application.

### Examples

The present invention is hereafter described with reference to the following Embodiments.

### Example 1

First, an acryl emulsion was introduced into a container so as to serve as an aqueous resin emulsion. A water retention agent, an expansion agent, a dispersant, an antifoaming agent, and carbon black were added thereto so as to serve as additives. Further, calcium carbonate and mica were mixed therewith so as to serve as inorganic fillers, followed by mixing with a disper mixer until a homogenous mixture was obtained. Thereafter, the mixture was transferred to a container for defoaming and the container was placed in a defoaming apparatus, followed by stirring for approximately 15 minutes during suction using a vacuum pump for defoaming. Thus, a water-based coating-type damping material was produced.

Herein, the portions of materials mixed were as follows: acryl emulsion: 40 parts (NV50%); calcium carbonate: 40 parts; mica: 10 parts; and additives: 10 parts. Among the additives, the content of the water retention agent was 1.5% by mass and the content of microballoon particles was 1.0% by weight. In addition, propylene glycol was used as the water retention agent. The microballoon particles used herein were polyacrylnitrile microballoon particles having particle sizes of 10 to 20 encapsulating liquid isobutane (hydrocarbon), and being capable of beginning to expand under temperature conditions of 80° C. or higher (the expansion initiation temperature: 80° C.) so as to achieve a maximum volume expansion rate (the maximum foaming rate) (at 120° C.) 8 times as great as the initial rate.

Then, a sealer and a water-based coating-type damping material were applied in layers to the surface of a steel plate. The plate was allowed to stand for several hours and heated in the same state to 130° C. Then, the degree of deformation of the sealer was confirmed. As a result, deformation and detachment of the sealer were not observed.

### Comparative Example 1

As in the case of Example 1, a water-based coating-type damping material was produced. Comparative Example 1 differed from Example 1 in that microballoon particles capable of starting to expand under temperature conditions above 100° C. (the water boiling point) were obtained for use by adjusting the amounts of an expansion agent and the like. Then, as in the case of Example 1, the degree of deformation of the sealer was confirmed.

### [Result 1

In Example 1, deformation and detachment of the sealer were not observed. However, in Comparative Example 1, deformation and partial detachment of the sealer and partial swelling of the coat were confirmed. Based on the results, the following was assumed. In the case of the water-based coating-type damping material obtained in Example 1, the moisture contained in the coat of the material was rapidly released due to expansion of microballoon particles of the material at a temperature (at the water boiling point or lower) at which rapid boiling of the moisture did not take place. Accordingly, it was possible to prevent swelling of the coat due to rapid boiling of the moisture.

In addition, the following was assumed. The microballoon particles obtained in Example 1 started to expand at a heating temperature at the water boiling point or lower such that micropores were formed on the coat surface before the water vapor contained in the coat was caused to affect (attack) the sealer, leading to prevention of deformation and detachment of the sealer.

As described above, the moisture in the coat can be released in a preferable manner such that the amount of a water retention agent added to a water-based coating-type damping material can be increased. Accordingly, dryness of the surface of the formed coat is alleviated, and thus skinning of the surface can be prevented, resulting in prevention of swelling of the coat upon heating.

### Example 2

As in the case of Example 1, a water-based coating-type damping material was produced. In the same manner as in Example 1, a sealer and a water-based coating-type damping material were applied in layers to the surface of a steel plate, followed by heating. Then, the degree of deformation of the sealer and the degree of formation of blisters upon electrodeposition were confirmed. Table 1 lists the results.

### Example 3

As in the case of Example 1, a water-based coating-type damping material was produced. Example 3 differed from Example 1 in that the content of propylene glycol in the water retention agent was 3.0% by mass. Then, as in the case of Example 2, the degree of deformation of the sealer and the degree of formation of blisters upon electrodeposition were confirmed with the use of the water-based coating-type damping material. Table 1 lists the results.

### Comparative Examples 2 and 3

As in the case of Example 1, a water-based coating-type damping material was produced. Comparative Examples 2 and 3 differed from Example 1 in that the contents of propylene glycol serving as a water retention agent were 0.5% by mass and 4.0% by mass in Comparative Examples 2 and 3, respectively. Then, as in the case of Example 2, the degree of deformation of the sealer and the degree of formation of blisters upon electrodeposition were confirmed with the use of the water-based coating-type damping material.

### Comparative Examples 4 and 5

As in the case of Example 1, a water-based coating-type damping material was produced. Comparative Examples 4 and 5 were different from Example 1 in that the microballoon particles used in Comparative Examples 4 and 5 were obtained by adjusting the amount of isobutene contained in the microballoon particles such that the expansion initiation temperature was 90° C. and the maximum volume expansion rate (the maximum foaming rate) (at 120° C.) was 4 times as great as the initial rate, and in that the contents of propylene glycol serving as a water retention agent were 1.0% by mass and 4.0% by mass in Comparative Examples 4 and 5, respectively. Then, as in the case of Example 2, the degree of deformation of the sealer and the degree of formation of blisters upon electrodeposition were confirmed with the use of the water-based coating-type damping material.

TABLE 1

| | | Moisture | | |
|---|---|---|---|---|
| | | retention | | |
| | Content of | agent | | |
| | microballoon | content | | Blister formation |
| | particles (% | (% by | Sealer | due to |
| | by mass) | mass) | deformation | electrodeposition |
| Example 2 | 1.0 | 1.5 | ◯ | ◯ |
| Example 3 | 1.0 | 3.0 | ◯ | ◯ |
| Comparative | 1.0 | 0.5 | X | ◯ |
| Example 2 | | | | |
| Comparative | 1.0 | 4.0 | ◯ | X |
| Example 3 | | | | |
| Comparative | 1.0 | 1.0 | X | ◯ |
| Example 4 | | | | |
| Comparative | 1.0 | 4.0 | Δ | X |
| Example 5 | | | | |

Sealer ◯: No detachment and no deformation; Δ: Detachment deformation only; X: interface detachment upon electrodeposition
Blister formation upon ◯: No blister formation; X: Blister formation electrodeposition

### [Result 2

In Examples 2 and 3, detachment and deformation of the sealer were not observed. Also, formation of blisters upon electrodeposition was not observed. In Comparative Examples 2 and 3 (the content of a water retention agent: less than 1.5% by mass), formation of blisters upon electrodeposition was not observed; however, detachment of the sealer in the interface between the sealer and an electrodeposited coat was observed in some cases. In addition, in Comparative Example 3 (the content of a water retention agent: more than 3.0% by mass), detachment and deformation of the sealer were not observed; however, formation of blisters upon electrodeposition was observed in some cases.

Based on the above results, it was assumed that skinning was likely to occur on the coat surface when the content of a water retention agent was less than 1.5% by mass as in the case of Comparative Example 2, resulting in insufficient release of water contained in the coat. Therefore, it is considered that if baking is carried out in the case of insufficient release of water, water vapor remains in gaps between a damping material (coat) and a sealer when the moisture in a damping material is evaporated. In addition, gelling of the sealer takes place before gelling of the damping material. Accordingly, detachment or deformation of the sealer is caused by water vapor when the water vapor pressure increases before allowing secure adhesion. In the case of Comparative Example 3 in which the content of a water retention agent was not less than 4.0% by mass, the amount of the moisture retained by a water retention agent was large, probably resulting in formation of blisters upon electrodeposition. Accordingly, it is considered that the content of a water retention agent in a water-based coating-type damping material is preferably 1.5% to 3.0% by mass.

### [Result 3

In addition, in Comparative Example 5, partial deformation of the sealer was confirmed, indicating the formation of blisters upon electrodeposition. Probably, this was because the foaming initiation temperature was higher and the volume expansion rate was lower in Comparative Example 5 than those in Examples 2 and 3. That is, formation of microspores in the coat was unlikely to be caused in Comparative Example 5 compared with Examples 2 and 3, resulting in insufficient release of moisture. Therefore, it was assumed that water vapor remained in gaps between the damping material and the sealer. Based on the above, the expansion initiation temperature of microballoon particles is preferably as low as possible. Further, the maximum expansion rate is preferably at least 8 times as great as the initial rate.

The present invention is described above in greater detail with reference to the following examples, although the technical scope of the present invention is not limited thereto. Various changes and modifications to the present invention can be made equally without departing from the spirit or scope thereof.

1. A water-based coating-type damping material, which comprises at least an aqueous resin emulsion, an inorganic filler, a water retention agent that retains the moisture of the resin emulsion, and microballoon particles comprising balloons encapsulating an expansion agent that is evaporated by heating so as to expand, the microballoon particles starting to expand in the presence of the expansion agent under heating temperature conditions of the water boiling point or lower.

2. The water-based coating-type damping material according to claim 1, wherein the content of the water retention agent in the water-based coating-type damping material is 1.5% to 3.0% by mass.

3. The water-based coating-type damping material according to claim 1, wherein the temperature at which the microballoon particles start to expand is 80° C. or higher.

4. The water-based coating-type damping material according to claim 3, wherein the microballoon particles encapsulate the expansion agent in an amount that allows the microballoon particles to expand in a volume at least 8 times as great as the initial volume via heating.

5. The water-based coating-type damping material according to claim 1, wherein the expansion agent is hydrocarbon and the water retention agent is propylene glycol.
